(19) United States
(12) Patent Application Publication
(10) Pub. No.: US 2010/0264810 A1
(43) Pub. Date: Oct. 21, 2010

(54) ELECTRODE FOR HOT CATHODE FLUORESCENT LAMP

(76) Inventors: Byung Hyun Kim, Gyeonggi-do (KR); Young Bok Lee, Kwangju-si (KR)

Correspondence Address: IPLA P.A., 3550 WILSHIRE BLVD., 17TH FLOOR, LOS ANGELES, CA, 90010, US

(21) Appl. No.: 12/810,054

(22) PCT Filed: Jan. 2, 2008
(86) PCT No.: PCT/KR2008/000010

§ 371 Date: Jun. 22, 2010

(30) Foreign Application Priority Data
Dec. 27, 2007 (KR) 10-2007-0138728

(51) Int. Cl. H01J 1/62

(52) U.S. Cl. 313/483

(57) ABSTRACT

An electrode of a hot cathode fluorescent lamp includes a pair of lead wires which are inserted from the outside into a glass tube, passing through a leading end of the glass tube, ends of each of the pair of lead wires protruding outward from an outer surface and inward from an inner surface of the glass tube, respectively, shape-keeping members with leading ends welded into and fixed to leading ends of the lead wires, respectively which protrude inward from the inner surface of the glass tube, a filament coil provided with leg portions which surround the shape-keeping members and are welded into and fixed to the lead wires along with the shape-keeping members at both leading ends of a coil portion for emitting electrons, and a sleeve installed inside the glass tube and surrounding the filament coil.

### TECHNICAL FIELD

The present invention relates to a hot cathode fluorescent lamp, and more particularly to an electrode of a hot cathode fluorescent lamp.

### BACKGROUND ART

Generally a hot cathode fluorescent lamp has an electrode with filament coils at both ends of a glass tube and has a structure in which an inert gas such as Ar, Kr, or Ne in a single or mixture gas form and Hg are sealed inside the glass tube and the inner surface of the glass tube is coated with a fluorescent material.

FIG. 1 shows an exemplary electrode of a hot cathode fluorescent lamp according to the related art.

The electrode 3 used in the hot cathode fluorescent lamp includes a filament coil 4 composed of a coil portion 4A and a first leg portion 4B and a second leg portion 4c connected to the coil portion 4A. The filament coil 4 is formed by preparing the cylinder-shaped coil portion 4A which is formed by spirally winding a metal wire such as tungsten wire in a double, triple, or quadruple spiral form and then preparing two leg portions 4B and 4C at the back of the coil portion 4A.

The electrode 3 includes a first filament coil tap 5A and a second filament coil tap 5B which support the filament coil 4. The coil tap 5A is connected to the first leg portion 4B of the filament coil 4 through a welding method. The second filament tap 5B is also connected to the second leg portion 4C of the filament coil 4 through the welding method.

In the electrode 3, the first filament coil tap 5A and the second filament coil tap 5B are connected to lead wires 6A and 6B, respectively. The lead wires 6A and 6B externally penetrate through the glass tube 1 and extend inward inside the glass tube 1.

A sleeve lead 8 supports a sleeve 7 while being fixed by the coil tap 5A.

As described above, the electrode of the related art hot cathode fluorescent lamp is composed of the coil portion 4A, the first leg portion 4B, the second leg portion 4C, the first filament coil tap 5A, the second filament coil tap 5B, and the lead wires 6A and 6B. That is, since a large number of parts are needed to form the hot cathode fluorescent lamp, the manufacturing process thereof is very complicated, resulting in high manufacturing cost. That is, it makes it difficult to manufacture the hot cathode fluorescent lamp.

### DISCLOSURE OF INVENTION

### Technical Problem

An object of some aspects of the invention is to provide a filament coil structure which can increase a coating amount of an electron emissive material to prolong the lifespan of a lamp, in a thin-tube hot cathode fluorescent lamp having a thin tube with a diameter of 2.0 mm, 2.4 mm, 3.0 mm, 3.4 mm, 4.0 mm, 5.0 mm, or 6.0 mm and an electrode of a hot cathode fluorescent lamp with a reduced number of parts and simplified manufacturing process compared to conventional hot cathode fluorescent lamps.

### Technical Solution

In order to accomplish such an object of the invention, there is provided an electrode of a hot cathode fluorescent lamp including a pair of lead wires which penetrate from the outside through opposite sides of a leading end of a glass tube, both ends of each of the lead wires protruding from an outer surface and an inner surface of the glass tube, respectively, shape-keeping members with leading ends welded into and fixed to leading ends of the lead wires which extend inside the glass tube, a filament coil provided with leg portions which surround the shape-keeping members and are welded into and fixed to the lead wires along with the shape-keeping members at both leading ends of a coil portion for emitting electrons, and a sleeve installed inside the glass tube and surrounding the filament coil.

### Advantageous Effects

According to the present invention, it is possible to reduce the number of parts of a hot cathode fluorescent lamp, for the purpose of simplifying the manufacturing process and lower the manufacturing cost of the hot cathode fluorescent lamp. Moreover, since the electrode is supported by the shape-keeping member, it is possible to prevent the electrode from shaking. Furthermore, it is possible to prolong the lifespan of the hot cathode fluorescent lamp by increasing a coating amount of an electron emissive material.

### BRIEF DESCRIPTION OF DRAWINGS

FIG. 1 is an exemplary view illustrating an electrode of a hot cathode fluorescent lamp according to the related art;

FIG. 2 is an exemplary view illustrating an electrode of a hot cathode fluorescent lamp according to one embodiment of the invention; and

FIG. 3 is an exemplary view illustrating an electrode of a hot cathode fluorescent lamp according to another embodiment of the invention.

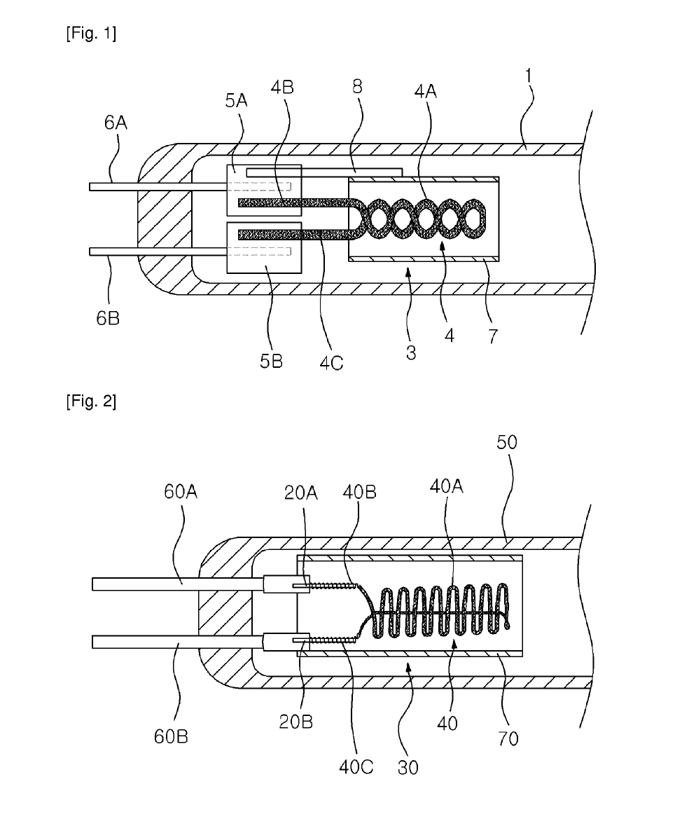

### DETAILED DESCRIPTION OF THE KEY ELEMENTS IN THE DRAWINGS

10A: First lead wire 10B: Second lead wire

20A: First shape-keeping member

20: Second shape-keeping member

30: Electrode 40: Filament coil

### MODE FOR THE INVENTION

Hereinafter, preferred embodiments of the invention will be described with reference to the accompanying drawings.

The following embodiments can be modified, changed, or altered in various forms and are not provided on purpose to limit the scope of the invention. The embodiments are provided to help people ordinarily skilled in the art understand the invention.

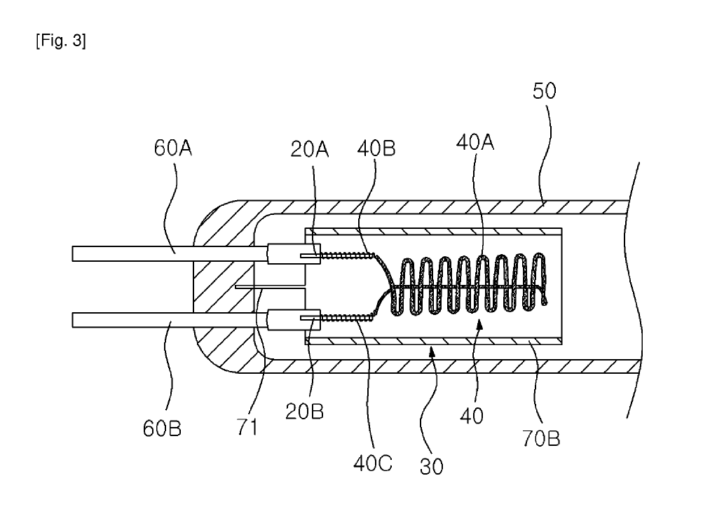

FIG. 2 is an exemplary view illustrating an electrode of a hot cathode fluorescent lamp according to one embodiment of the invention.

The electrode 30 includes first and second lead wires 60A and 60B, a filament coil 40, and shape-keeping members 20A and 20B. The filament coil 40 is composed of a coil portion 40A and leg portions 40A and 40B. Each of elements of the electrode 30 will be described below in detail.

The first lead wire 60A and the second lead wire are externally inserted into a glass tube 50 in parallel with the glass substrate 50, penetrating through both sides of an end of the glass tube 50, respectively, and fixed in such a state. The first and second lead wires 60A and 60B function to supply electric power to the filament coil 40. The first and second lead wires 60A and 60B are fixed in a manner such that bead glass is inserted into the glass tube 50 and heated so that the glass tube 50 and the glass beads are fused together.

The surface of the glass tube 50 is coated with a protective film made of ultrafine particles of Al₂O₃, SiO₂, or Y₂O₃ that can block ultraviolet (UV) rays. That is, the protective film is provided between the glass tube and a fluorescent film. The protective film suppresses eduction of sodium contained in glass and blocks the UV rays. As a result, it is possible to suppress blackening and staining which cause the lowering of brightness and also to inhibit consumption of mercury which is caused by mercury and sodium combining. Blackening is a phenomenon in which a mercury compound produced by reaction between sodium educed from the glass of the fluorescent lamp and mercury sealed in the lamp becomes attached to the inner surface of the glass tube of the fluorescent lamp. The staining gives rises to a problem of lowering transmittance of the glass tube of the fluorescent lamp with respect to ultraviolet rays by deteriorating the glass.

The first shape-keeping member 20A is fixed to a leading end of the first lead wire 60A protruding from the inner surface of the glass tube 50 through a welding method, and the second shape-keeping member 20B is fixed to a leading end of the second lead wire 60B through a welding method. When the first shape-keeping member 20A is welded into and fixed to the first lead wire 60A, the first leg portion 40B of the filament coil 40 is combined with the first shape-keeping member 20A. That is, the first lead wire 60A, the first shape-keeping member 20A, and the first leg portion 40B of the filament coil 40 are welded into and fixed to one another.

When the second shape-keeping member 20B is welded into and fixed to the second lead wire 60B, the second leg portion 40C of the filament coil 40 is combined with the second shape-keeping member 20B. That is, the second lead wire 60B, the second shape-keeping member 20B, and the second leg portion 40C of the filament coil 40 are welded into and fixed to one another.

The first lead wire 60A and the second lead wire 60B have planar surfaces at end portions thereof because the end portions are press-processed. The planar surface formed at the end of the first lead wire facilitates welding between the first lead wire 60A and the first shape-keeping member 20A. The planar surface formed at the end of the second lead wire facilitates welding between the second lead wire 60B and the second shape-keeping member 20B.

The first shape-keeping member 20A supports the first leg portion 40B of the coil portion 40A of the filament coil 40 and thus prevents the filament coil 40 from shaking. Similarly, the second shape-keeping member 20B supports the second leg portion 40C of the coil portion 40A of the filament coil and thus prevents the filament coil 40 from shaking.

The filament coil 40 is composed of the coil portion 40A, the first leg portion 40B, and the second leg portion 40C. The filament coil 40 generates heat so that electrons are emitted from the electron emissive material coated on the coil portion 40A, and is provided with the first and second leg portions 40B and 40C at both ends thereof. The coil portion 40A may take various forms. For example, the coil portion 40A may have a double spiral coiled structure, a triple spiral coiled structure, or a quadruple spiral coiled structure. The coil portion 40A may have a structure in which windings of the double-coil, the triple-coil, or the quadruple-coil are arranged in a horizontal direction and the wire of the coil extends from an end of the coil portion while passing through the center of the coil portion and terminates at the other end side of the coil portion.

The first leg portion 40B is inserted into the first shape-keeping member 20A and thus it is fixed. An end of the first leg portion 40B is welded into and fixed to the first lead wire 60A. The second leg portion 4C is inserted into the second shape-keeping member 20B and it is fixed. An end of the second leg portion 40C is welded into and fixed to the second lead wire 60B.

The sleeve 70 has a cylindrical shape and surrounds the filament coil 40. The sleeve 70 is welded into and fixed to the second lead wire 60B and prevents a metal oxide evaporating from the filament coil 40 from becoming fused and deposited on the glass tube 50. The sleeve 70 is made of one metal of nickel (Ni), molybdenum (Mo), niobium (Nb), and tungsten (W), or an alloy of those metals. Such a sleeve 70 is coated with a getter of which a main component is zirconium (Zr), titanium (Ti), or aluminum (Al), and the upper surface or the side surface of the getter is coated with an alloy of mercury (Hg) and titanium (Ti). Zr which is the primary component of the getter adsorbs oxygen and nitrogen. The getter is manufactured so as to be able to adsorb carbon dioxide (CO₂), hydrogen (H₂), and moisture (H₂O) as well as oxygen (O2) and nitrogen (N2). That is, owing to the getter, it is possible to improve optical characteristics and prolong the lifespan of the lamp.

Alternatively, the sleeve 70 can be welded into the first lead wire 60A. Further, the sleeve 70 may be provided with a lead member and the lead member can be fixed to a leading end of the glass tube 50. As shown in FIG. 3, the lead member of the sleeve 70 is fixed in a manner such that the lead member 71 of the sleeve 70 is inserted into the leading end of the glass tube 50.

A manufacturing method of the electrode of the hot cathode fluorescent lamp will be described below. The below-described method is provided for only illustrative purposes, and therefore the order of processes can be changed for the sake of making the work easier.

The coil portion 40A, the first leg portion 40B, and the second leg portion 40C of the filament coil 40 are configured in a manner such that a refractory metal wire such as tungsten wire is spirally wound to form the double spiral windings, the triple spiral win dings, or the quadruple spiral windings. The filament coil 40 is formed by spirally winding a refractory metal wire such as tungsten wire around the shape-keeping member having a shape corresponding to the shape of the filament coil 40. The shape-keeping member is placed at the centers of the coil portion 40A, the first leg portion 40B, and the second leg portion 40C of the filament coil 40.

The shape-keeping member is provided by leaving the molybdenum core wire, which is essentially used when forming windings of the filament coil, undissolved in the leg portions 40B and 40C. Ends of the first and second leg portions 40B and 40C in which the shape-keeping members are provided are bonded to the press-processed first and second leads 60A and 60B, respectively through a welding method. That is, the shape-keeping member and the first leg portion 40B are welded into the first lead wire 60A, and the shape-keeping member and the second leg portion 40C are welded into the second lead wire 60B.

The sleeve 70 is welded into the first lead wire 60A or the second lead wire 60B. Besides such a bonding structure in which the sleeve 70 is welded into the first lead wire 60A or the second lead wire 60B, the sleeve 70 may be fixed to a glass tube ahead the first lead wire 60A and the second lead wire 60B, or may be fixed to the glass member when the first lead wire 60A and the second lead wire 60B are fixed to the glass member.

The first lead wire 60A and the second lead wire 60B are inserted into a bead glass with holes which allow the first and second lead wires 60A and 60B to pass therethrough. The bead glass is inserted into the glass tube 50, and then the bead glass and the glass tube 50 are heated together so that ends of the glass tube 50 are sealed. When the ends of the glass tube 50 are sealed, the inside space of the glass tube 50 is treated to fall into the vacuum state, and then one or more gases of argon (Ar), krypton (Kr), and neon (Ne), and mercury are injected into the sealed glass tube.

While a preferred embodiment of the invention has been described using specific terms, such description is for illustrative purpose only, and it will be apparent to those skilled in the art that various modifications, variations, and equivalents may be made from the embodiment. Accordingly, the substantial scope of the invention may be determined by the technical spirit of the following claims.

1. An electrode of a hot cathode fluorescent lamp comprising:
a pair of lead wires which are inserted from the outside into a glass tube, passing through a leading end of the glass tube, ends of each of the pair of lead wires protruding outward from an outer surface and inward from an inner surface of the glass tube, respectively;
shape-keeping members with leading ends welded into and fixed to leading ends of the lead wires, respectively, which protrude inward from the inner surface of the glass tube;
a filament coil provided with leg portions which surround the shape-keeping members and are welded into and fixed to the lead wires along with the shape-keeping members at both leading ends of a coil portion for emitting electrons; and
a sleeve installed inside the glass tube and surrounding the filament coil.

2. The hot cathode fluorescent lamp according to claim 1, wherein ends of the lead wires which extend in the glass tube are press-processed and thus have planar surfaces, and the planar surfaces serve as welding faces.

3. The hot cathode fluorescent lamp according to claim 1, wherein the sleeve is welded into any one of the pair of lead wires extending inside the glass tube.

4. The hot cathode fluorescent lamp according to claim 1, wherein the sleeve is made of one metal of Ni, Mo, Nb, and W, or an alloy thereof and is coated with a getter of which a primary component is Zr, Ti, or Al, and wherein an upper surface or a side surface of the getter is coated with an alloy of Hg and Ti.

5. The hot cathode fluorescent lamp according to claim 1, wherein a surface of the glass tube is coated with a protective film of ultrafine particles made of Al₂O₃, SiO₂, or Y₂O₃, the protective film being provided between the glass tube and a fluorescent film.
